(19) United States
(12) Patent Application Publication
(10) Pub. No.: US 2020/0081535 A1
(43) Pub. Date: Mar. 12, 2020

(54) EMOTION RECOGNITION APPARATUS AND CONTROL METHOD THEREOF

(71) Applicants: HYUNDAI MOTOR COMPANY, Seoul (KR); KIA MOTORS CORPORATION, Seoul (KR)

(72) Inventors: Seunghyun WOO, Seoul (KR); Dong-Seon Chang, Hwaseong-si (KR); Daeyun An, Anyang-si (KR)

(73) Assignees: HYUNDAI MOTOR COMPANY, Seoul (KR); KIA MOTORS CORPORATION, Seoul (KR)

(21) Appl. No.: 16/211,600

(22) Filed: Dec. 6, 2018

(30) Foreign Application Priority Data
Sep. 7, 2018 (KR) 10-2018-0107302

(51) Int. Cl. G06F 3/01; G06K 9/00; G10L 25/63

(52) U.S. Cl. CPC G06F 3/015; G06F 2203/011; G10L 25/63; G06K 9/00302

(57) ABSTRACT

An emotion recognition apparatus and controlling method thereof is provided. The emotion recognition apparatus includes: a communicator; a sensing part configured to collect a user's bio-signal using at least one sensor; a feedback device configured to adjust an feedback element; a storage configured to store correlation information between the user's bio-signal and an emotion factor and correlation information between the emotion factor and the feedback element; and a controller configured to acquire user's situation information through the communicator, acquire user's emotion information on the basis of the user's bio-signal, determine whether feedback information is allowed to be provided on the basis of at least one of the user's situation information and the user's emotion information, and control the feedback device to provide the feedback information when the feedback information is allowed to be provided, to make a user feel familiar with feedbacks of the apparatus.

### CROSS-REFERENCE TO RELATED APPLICATION

The present application claims priority to and the benefit of Korean Patent Application No. 10-2018-0107302, filed on Sep. 7, 2018, which is incorporated herein by reference in its entirety.

### TECHNICAL FIELD

Forms of the present disclosure relate to an emotion recognition apparatus and a control method thereof which allow a user to feel familiarity with feedbacks of an apparatus by reflecting a user's situation to feedback information in recognizing user's emotions and providing the feedback information.

### BACKGROUND

The statements in this section merely provide background information related to the present disclosure and may not constitute prior art.

Recently, apparatuses that are equipped with artificial intelligence to respond to user's emotions and operate are appearing. For example, there are robots which respond to user's emotions and provide various feedbacks.

However, in the related art, during an interaction with a user, user's situations are not specifically considered, and feedbacks in response to user's emotions are unilaterally provided, so that the user may feel uncomfortable.

Further, in the related art, when feedback information is provided, feedback elements such as a tone, a volume, and the like are uniformly maintained, so that the user does not feel familiar.

Therefore, a technique that allows the user to be more sympathetic and feel a familiarity in providing feedbacks on the basis of user's emotions may be desired.

### SUMMARY

Therefore, it is an aspect of the present disclosure to provide an emotion recognition apparatus and a control method thereof, which prevent feedback information from being provided in a situation in which feedbacks of the apparatus are unnecessary by determining in advance whether to provide the feedback information on the basis of user's situation information and user's emotion information.

It is another aspect of the present disclosure to provide an emotion recognition apparatus and a control method thereof, which allows a user to feel more familiar with a response of an apparatus by variously adjusting feedback elements according to user's emotions.

Additional aspects of the disclosure will be set forth in part in the description which follows and, in part, will be obvious from the description, or may be learned by practice of the disclosure.

In accordance with one aspect of the present disclosure, an emotion recognition apparatus includes: a communicator; a sensing part configured to collect a user's bio-signal using at least one sensor; a feedback device configured to adjust an feedback element; a storage configured to store correlation information between the user's bio-signal and an emotion factor and correlation information between the emotion factor and the feedback element; and a controller configured to acquire user's situation information through the communicator, acquire user's emotion information on the basis of the user's bio-signal, determine whether feedback information is allowed to be provided on the basis of at least one of the user's situation information and the user's emotion information, and control the feedback device to provide the feedback information when the feedback information is allowed to be provided.

The controller may determine whether the feedback information is allowed to be provided on the basis of at least one of current location information, current time information, weather information, and user's schedule information included in the user's situation information.

The controller may determine whether the feedback information is allowed to be provided on the basis of a degree of positive emotion and a degree of excitement included in the user's emotion information.

The controller may set a target emotion on the basis of the user's emotion information, and control the feedback device so that a user's current emotion reaches the target emotion.

The controller may acquire the user's emotion information on the basis of the correlation information between the user's bio-signal and the emotion factor, and control the feedback device on the basis of the correlation information between the emotion factor and the feedback element.

The controller may extract emotion factors which affect the user's current emotion from the user's emotion information and control the feedback device to enhance or weaken a specific emotion factor among the extracted emotion factors so that a user's emotion reaches the target emotion.

The controller may control the feedback device such that the feedback element corresponding to the specific emotion factor is adjusted on the basis of the correlation information between the emotion factor and the feedback element.

The feedback information may include at least one of executable function information corresponding to the user's emotion information and an emotion expression image corresponding to the user's emotion information.

The controller may control the feedback device so that the feedback element related to a specific function is adjusted when the specific function is selected by a user from the executable function information.

The emotion recognition apparatus may further include an input part configured to receive at least one of the user's situation information and the target emotion from a user.

The feedback device may include at least one of a display and a speaker.

In accordance with another aspect of the present disclosure, a control method of an emotion recognition apparatus, including: collecting a user's bio-signal using at least one sensor; acquiring user's situation information; receiving correlation information between the user's bio-signal and an emotion factor and correlation information between the emotion factor and a feedback element; acquiring user's emotion information on the basis of the user's bio-signal; determining whether feedback information is allowed to be provided on the basis of at least one of the user's situation information and the user's emotion information; and controlling a feedback device to provide the feedback information when the feedback information is allowed to be provided.

The determining of whether the feedback information is allowed to be provided may include determining whether the feedback information is allowed to be provided on the basis of at least one of current location information, current time information, weather information, and user's schedule information included in the user's situation information.

The determining of whether the feedback information is allowed to be provided may include determining whether the feedback information is allowed to be provided on the basis of a degree of positive emotion and a degree of excitement included in the user's emotion information.

The controlling of the feedback device may further include; setting a target emotion on the basis of the user's emotion information; and controlling the feedback device so that a user's current emotion reaches the target emotion.

The acquiring of the user's emotion information may include acquiring the user's emotion information on the basis of the correlation information between the user's bio-signal and the emotion factor, and the controlling of the feedback device includes controlling the feedback device on the basis of the correlation information between the emotion factor and the feedback element.

The controlling of the feedback device may further include: extracting an emotion factor which affects the user's current emotion from the user's emotion information; and enhancing or weakening a specific emotion factor of the extracted emotion factors.

The controlling of the feedback device may further include adjusting the feedback element corresponding to the specific emotion factor on the basis of the correlation information between the emotion factor and the feedback element.

The feedback information may include at least one of executable function information corresponding to the user's emotion information and an emotion expression image corresponding to the user's emotion information.

The controlling of the feedback device may include adjusting the feedback element related to the specific function when a specific function is selected by a user from the executable function information.

The control method of an emotion recognition apparatus may further include receiving at least one of the user's situation information and the target emotion from a user.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating a configuration of an emotion recognition apparatus in one form of the present disclosure;

FIG. 2 is a table illustrating correlation information between bio-signals and emotion factors;

FIG. 3 is a view illustrating an emotion model;

FIG. 4 is a table illustrating correlation information between the emotion factors and feedback elements;

FIGS. 5 and 6 are views for describing a method of making a user's emotion reach a target emotion; and

FIG. 7 is a flowchart illustrating a control method of the emotion recognition apparatus in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Throughout this specification, when a part is referred to as being “connected” to other parts, it includes not only a direct connection but also an indirect connection, and the indirect connection includes a connection through a wireless communication network.

Further, when a part is referred to as “including” a component, this means that the part can include another element, and does not exclude another element unless specifically stated otherwise.

Terms “first,” “second,” and the like are used to distinguish one component from other components, and components are not limited by these terms.

In each step, a reference numeral is used for convenience of description, and this reference numeral does not describe the order of the steps, and the steps may be differently performed from the described order unless clearly specified in the context.

Hereinafter, an operation principle and some forms of the present disclosure will be described with reference to the accompanying drawings.

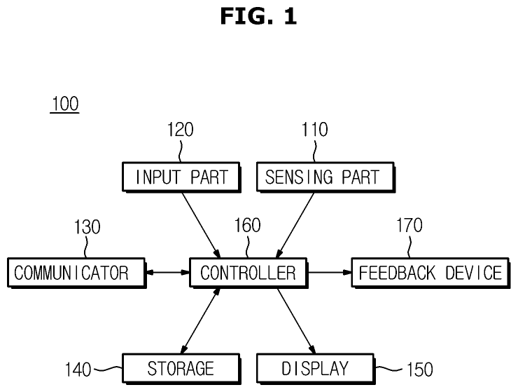

FIG. 1 is a view illustrating a configuration of an emotion recognition apparatus in one form of the present disclosure.

Referring to FIG. 1, an emotion recognition apparatus 100 may include a sensing part 110, an input part 120, a communicator 130, a storage 140, a display 150, a controller 160, and a feedback device 170.

The sensing part 110 may collect user's bio-signals using at least one sensor provided in the emotion recognition apparatus 100. The collected user's bio-signals may be stored in the storage 140 or transmitted to the controller 160.

The sensing part 110 may include at least one of a galvanic skin response (GSR) sensor configured to measure electrical conductivity of a user's skin, a skin temperature sensor configured to measure a temperature of the user's skin, a heart rate (HR) sensor configured to measure a user's heart rate, a electroencephalogram (EEG) sensor configured to measure a user's brainwave, a voice recognition sensor configured to measure a user's voice signal, a face analysis device capable of analyzing user's facial expression, and an eye tracker capable of tracking positions of user's pupils. Sensors that the sensing part 110 may include are not limited to the above-described sensors, and the sensing part 110 may include all sensors capable of measuring or collecting human bio-signals.

The input part 120 may receive at least one of user's situation information, a current emotion, and a target emotion, and a function execution command from the user.

The user's situation information is a concept including at least one of current location information, current time information, weather information, and user's schedule information. Further, when the emotion recognition apparatus 100 is provided in a vehicle, and the user drives the vehicle, the user's situation information may further include road information, road traffic situation information, and the like. The user's situation information may be stored in an external server.

The communicator 130 may communicate with the external server to transmit and receive the user's situation information. Further, the communicator 130 may also receive correlation information between the user's bio-signals and emotion factors, correlation information between emotion factors and feedback elements, and an emotion model from the external server which will be described below.

The communicator 130 may transmit and receive data using various communication methods. For example, the communicator 130 may use Wi-Fi, Bluetooth, ZigBee, an ultra-wide band (UWB) communication method, or a near field communication (NFC) method.

The storage 140 stores the user's bio-signals collected by the sensing part 110, the correlation information between the user's bio-signals and the emotion factors, the correlation information between the emotion factors and the feedback elements, the user's situation information, user's emotion information, and the emotion model. The pieces of information stored in the storage 140 may be transmitted to the controller 160.

The display 150 is a device configured to display a variety of information. A screen displayed on the display 150 is controlled by the controller 160. The display 150 may include a panel, and the panel may be one of a cathode ray tube (CRT) panel, a liquid crystal display (LCD) panel, a light emitting diode (LED) panel, an organic light emitting diode (OLED) panel, a plasma display panel (PDP), and a field emission display (FED) panel.

Further, the display 150 may also include a touch panel which receives a touch input, thereby receiving a user's input through a touch. When the display 150 includes the touch panel, the display 150 may perform a role of the input part 120.

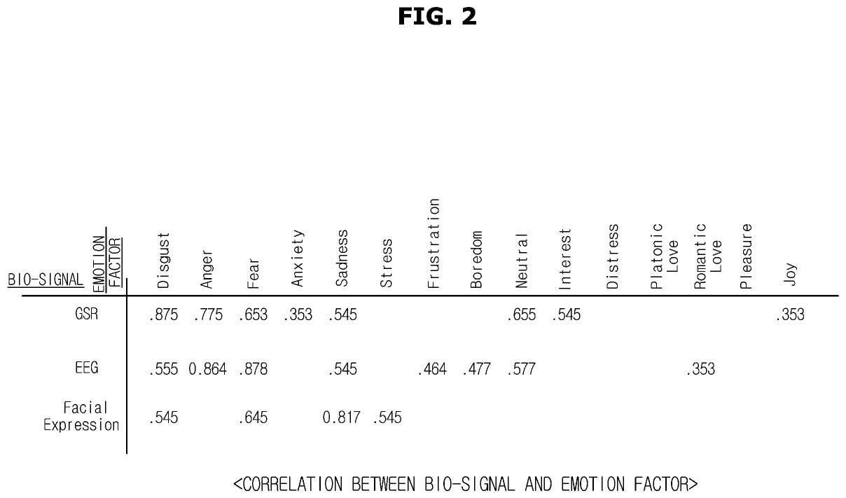

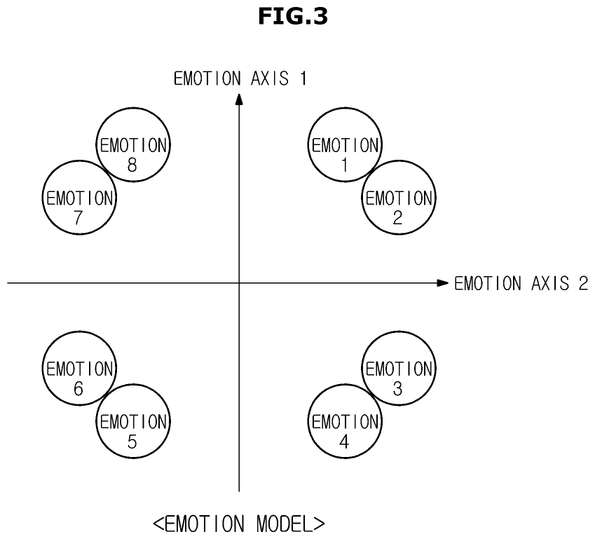

The controller 160 acquires the user's situation information from the external server through the communicator 130 and acquires the user's emotion information on the basis of the user's bio-signals received from the sensing part 110. A method of acquiring the user's emotion information will be described below with reference to FIGS. 2 and 3.

The controller 160 may determine whether feedback information can be provided on the basis of at least one of the user's situation information and the user's emotion information. That is, the controller 160 may determine whether the user is in an appropriate situation to receive the feedback information.

The feedback information may include at least one of executable function information corresponding to at least one of the user's emotion information and the user's situation information, and emotion expression images corresponding to the user's emotion information. The emotion expression images are a concept including both static images and dynamic images and include pictures, emoticons, avatars, and the like, which may express emotions. Further, the feedback information may include the executable function information to improve user's emotions to positive emotions or maintain the user's emotions. For example, the executable function information may include playing music, playing video, providing shopping information, providing an optimum path, and the like.

The controller 160 may analyze a user's situation on the basis of at least one of the current location information, the current time information, the weather information, and the user's schedule information, which are included in the user's situation information. For example, when the user is currently at home and a current time is 8:50 A.M., but there is a schedule to go to work by 9 o'clock, the controller 160 may analyze that the user is likely to be perceived.

In this case, the user is in an urgent situation, and thus the user may be hard to respond to the feedback information provided from the emotion recognition apparatus 100. Rather, the user may feel negative emotions such as annoyingness when the feedback information is provided. In such a case, it may be inappropriate to provide the feedback information to the user. Accordingly, the controller 160 determines that it is impossible to provide the feedback information to the user, and may determine not to provide the feedback information to the user.

Further, the controller 160 may determine whether the feedback information can be provided on the basis of a degree of positive emotion and a degree of excitement included in the user's emotion information. For example, the controller 160 may also determine not to provide the feedback information to the user when the acquired user's emotion is a very negative emotion. When the user's emotion is in a very angered emotion or in a very annoyed emotion, the user may be in a state of not accepting any piece of information. In this case, the user's negative emotion may get worse due to the feedback information itself provided by the emotion recognition apparatus 100. Accordingly, the controller 160 may determine not to provide the feedback information when the user's emotion is in the negative emotion below a predetermined reference. Here, the predetermined reference may be set in advance on the basis of the emotion model.

That is, the controller 160 may determine whether it is appropriate to provide the feedback information to the user on the basis of at least one of the user's situation information and the user's emotion information. In other words, the controller 160 may determine whether it is a situation in which interaction with the user is possible.

Further, since the feedback information need not be provided even when the user directly inputs a function execution command using the input part 120, the controller 160 may determine not to provide the feedback information to the user.

As described above, whether the emotion recognition apparatus 100 is responded or not may be determined according to the user's situation and the user's emotion, so that the feedback information may be prevented from being provided even in the situation in which the feedbacks of the emotion recognition apparatus 100 is unnecessary. Accordingly, a sense of refusal of the user due to the unnecessary feedback information may be prevented from being generated.

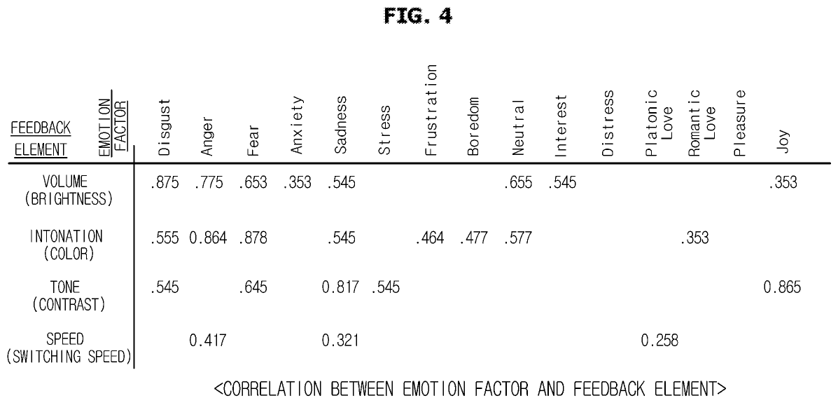

When the controller 160 determines to provide the feedback information, the controller 160 may control so that the feedback information is generated and output through the display 150 or the feedback device 170. Further, the controller 160 sets the target emotion on the basis of the user's emotion information and controls the feedback device 170 so that a user's current emotion reaches the target emotion. When a specific function is selected by the user from the executable function information included in the feedback information, the controller 160 may set the target emotion related to the specific function. A method for setting the target emotion, and a method for controlling the feedback device 170 so that the user's emotion reaches the target emotion will be described in detail in FIGS. 4 to 6 below.

The feedback device 170 may adjust the feedback elements so that the user's emotion reaches the target emotion. Specifically, the feedback device 170 may adjust the feedback element related to the specific function when the specific function is selected by the user from the executable function information included in the feedback information.

The feedback elements are elements related to the set of functions of the feedback device 170, for example, the feedback elements may include at least one of a volume, a tone, an intonation, a speed, and a frequency band related to a voice or a sound output through a speaker. Further, the feedback element may include brightness, contrast, a color, and a switching speed related to the screen output through the display.

For example, when a function of providing an optimum path is selected from the executable function information, the optimum path may be provided by the voice. Here, at least one of the volume, the tone, the intonation, the speed, and the frequency band of the voice may be adjusted.

The feedback device 170 is a device including at least one of the display and the speaker and may correspond to a multimedia device. The feedback device 170 may include a separate display which is distinct from the display 150 of FIG. 1, or the display 150 may be included in the feedback device 170. When the emotion recognition apparatus 100 is provided in the vehicle, various devices provided in the vehicle may correspond to the feedback device 170.

When a case in which the emotion recognition apparatus 100 is installed in the vehicle is specifically described, the sensing part 110 of the emotion recognition apparatus 100 may be installed in a seat in the vehicle or at a specific place inside the vehicle. Further, the input part 120, the display 150, and the feedback device 170 may correspond to a navigation system, a jog shuttle, and an audio video navigation (AVN) system provided in a center face of the vehicle.

The controller 160 controls the feedback device 170 on the basis of the correlation information between the emotion factors and the feedback elements to adjust the feedback elements so that the user's emotion reaches the target emotion.

FIG. 2 is a table illustrating the correlation information between the bio-signals and the emotion factors.

Referring to FIG. 2, the controller 160 may use the user's bio-signals collected by the sensing part 110 and the correlation information between the user's bio-signals and the emotion factors stored in the storage 140 to acquire the user's emotion information.

In FIG. 2, a galvanic skin response (GSR) signal has a correlation value of 0.875 and 0.775 with an emotion factor of disgust and an emotion factor of anger, respectively, and it may be seen that the GSR signal has high relevance with the emotion factor of disgust and the emotion factor of anger. Accordingly, the user's bio-signals collected by a GSR measurement device serve as a basis for determining that the user's emotion is in an angered emotion or in a disgusted emotion.

In the case of an emotion factor of joy, since the correlation value with the GSR signal has a relatively low value (0.353), it may be referred that the emotion factor of joy is less relevant to the GSR signal.

Also, an electroencephalogram (EEG) signal has a correlation value of 0.864 and 0.878 with the emotion factor of anger and an emotion factor of fear, respectively, and it may be seen that the EEG signal has higher relevance with the emotion factor of anger and the emotion factor of fear than other emotion factors. Accordingly, the bio-signals collected by an EEG measurement device serve as a basis for determining that the user's emotion is in the angered emotion or in a feared emotion.

As described above, the controller 160 may acquire the user's emotion information using the correlation information between the user's bio-signals and the emotion factors. Since the pieces of information shown in FIG. 2 are only results obtained by experiments, the information may vary depending on the experimental environment.

FIG. 3 is a view illustrating the emotion model.

Referring to FIG. 3, the emotion model is a classification of the user's emotions obtained according to the user's bio-signals on a graph. The emotion model classifies the user's emotions on the basis of preset emotion axises. The emotion axises may be determined on the basis of the emotions measured by the sensors. For example, an emotion axis 1 may be a degree of positive emotion measurable by the user's voice or face analysis, and an emotion axis 2 may be a degree of excitement measurable by the GSR or EEG.

When the user's emotions have a high degree of positive emotion and a high degree of excitement, the corresponding emotions may be classified as an emotion 1 or an emotion 2. On the contrary, when the user's emotions have a minus (−) degree of positive emotion, that is, a degree of negative emotion, and a high degree of excitement, the corresponding emotions may be classified as an emotion 3 or an emotion 4.

The emotion model may be a Russell's emotion model. The Russell's emotion model is represented by a two-dimensional graph based on an x-axis and a y-axis, and classifies the emotions into eight areas such as pleasure (0°), excitation (45°), arousal (90°), distress (135°), displeasure (180°), depression (225°), sleepiness (270°), and relaxation (315°). Further, the eight areas are divided into 28 emotions which are classified into similar emotions belonging to the eight areas.

As described above, the controller 160 may generate the emotion model on the basis of the user's emotion information, which is acquired using the correlation information between the user's bio-signals and the emotion factors. The emotion model is subsequently used when setting the target emotion.

FIG. 4 is a table illustrating the correlation information between the emotion factors and the feedback elements.

Referring to FIG. 4, the feedback elements may be the volume, the tone, the intonation, or the speed related to the voice or sound output through the speaker, and may be the brightness, the contrast, the color, or the switching speed related to the screen output through the display. The feedback elements may be variously defined in relation to the functions of the feedback device 170.

In FIG. 4, the emotion factor of fear is shown to be related to the volume (the brightness), the tone (the contrast), and the intonation (the color). Among these, the correlation value between the emotion factor of fear and the intonation (the color) is 0.864, and the emotion factor of fear has the highest relevance with the intonation (the color). Thus, when the user's emotion information is the feared emotion, the feedback information is provided by adjusting the intonation or color, thereby inducing changes in the user's emotions, which may be the most efficient way of providing feedback information.

Alternatively, it may be seen that an emotion factor of sadness is associated with the volume (the brightness), the tone (the contrast), the intonation (the color), and the speed (the switching speed). Among these, the correlation value between the emotion factor of sadness and the tone (the contrast) is 0.817, and the emotion factor of sadness has the highest relevance with the tone (the contrast). Thus, when the user's emotion information is the sad emotion, the feedback information is provided by adjusting the tone or contrast, thereby inducing changes in the user's emotions, which may be the most efficient way of providing feedback information.

As described above, the controller 160 may control the feedback device 170 such that the feedback element corresponding to a specific emotion factor is adjusted on the basis of the correlation information between the emotion factors and the feedback elements. Since the pieces of information shown in FIG. 4 are only results obtained by experiments, the information may vary depending on the experimental environment.

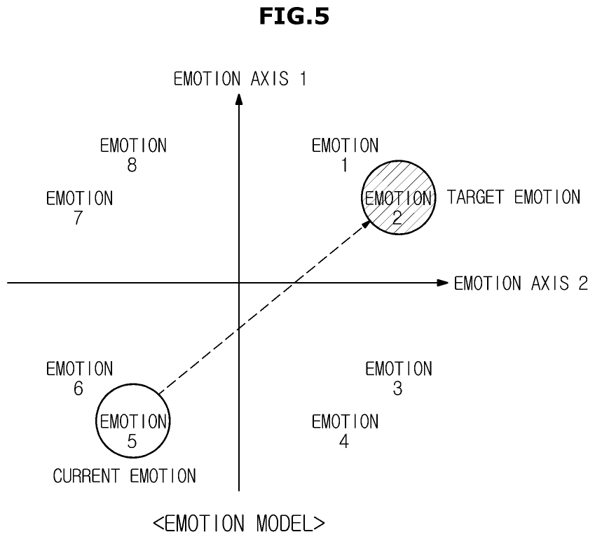

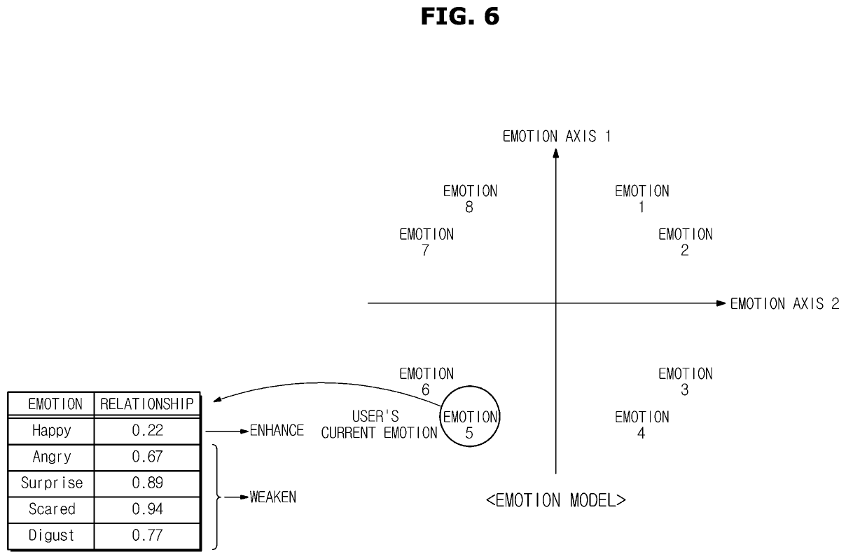

FIGS. 5 and 6 are views for describing a method of making a user's emotion reach a target emotion.

Referring to FIG. 5, the controller 160 sets the target emotion on the basis of the user's emotion information. The acquired user's current emotion information as a result of analyzing the user's bio-signals may be mapped to an emotion 5 on the emotion model. The user's emotion corresponding to the emotion 5 may be a negative emotion with a low degree of excitement. Accordingly, the controller 160 may set the target emotion as an emotion corresponding to the emotion 2 on the emotion model so that the user's emotion is changed to a positive emotion with the high degree of excitement. When the user's current emotion has the high degree of positive emotion, the current emotion may be maintained. That is, the target emotion may be variously set according to the user's situation and/or the user's current emotion.

The target emotion may also be set by a user's input. The user may input his/her desired target emotion using the input part 120.

When the target emotion is set, the controller 160 extracts emotion factors which affect the user's current emotion from the user's emotion information and enhances or weakens the specific emotion factor among the extracted emotion factors so that the user's emotion reaches the target emotion. That is, the controller 160 may control the feedback device 170 such that the feedback element corresponding to the specific emotion factor is adjusted on the basis of the correlation information between the emotion factors and the feedback elements.

Referring to FIG. 6, the controller 160 acquires the user's emotion information from the user's bio-signals to determine that the user's current emotion corresponds to emotion 5 on the emotion model and extracts emotion factors which affect the user's current emotion. Further, the controller 160 may classify a positive emotion factor as a first group and a negative emotion factor as a second group from the emotion factors which affect the user's current emotion.

In FIG. 6, the emotion factors affecting the user's current emotions were extracted as Happy, Angry, Surprise, Scared, and Disgust. Here, the Happy is the positive emotion factor and may be classified into the first group, and the Angry, the Surprise, the Scared, and the Disgust are the negative emotion factors and may be classified into the second group.

Since the user's current emotion is set to a negative emotion with a low degree of excitement which belongs to the emotion 5 on the emotion model and the target emotion is set to a positive emotion with a high degree of excitement which belongs to the emotion 2 on the emotion model, the controller 160 may control the feedback device 170 to enhance the emotion factors belonging to the first group and to weaken the emotion factors belonging to the second group.

The enhancing or weakening of the specific emotion factor is made on the basis of the correlation information between the emotion factors and the feedback elements described in FIG. 4. That is, the feedback device 170 may adjust the feedback element corresponding to the specific emotion factor so that the corresponding emotion factor is enhanced or weakened.

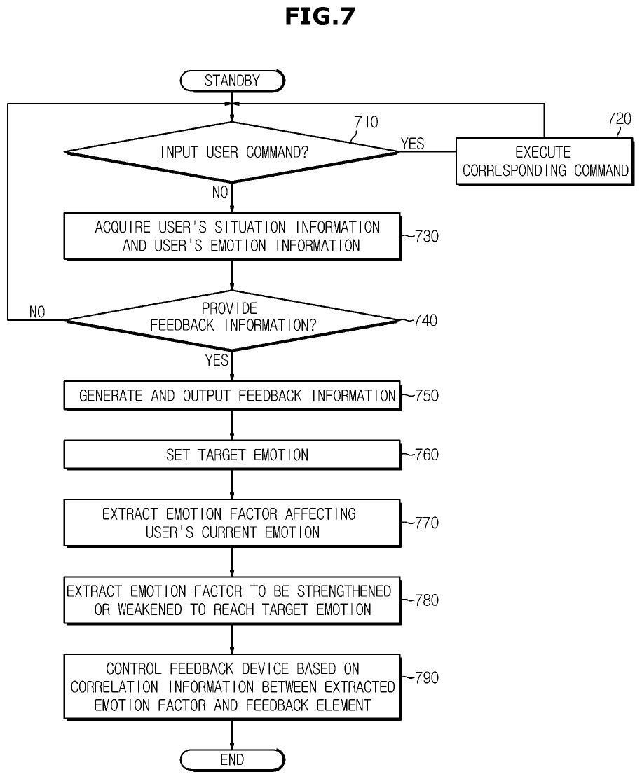

FIG. 7 is a flowchart illustrating a control method of the emotion recognition apparatus in one form of the present disclosure.

As described above, an emotion recognition apparatus 100 may include a sensing part 110, an input part 120, a communicator 130, a storage 140, a display 150, a controller 160, and a feedback device 170. As an example, the emotion recognition apparatus 100 may be provided in a vehicle, and various devices provided in the vehicle may correspond to the feedback device 170.

Referring to FIG. 7, the emotion recognition apparatus 100 may receive a user command in a standby state (710). When there is the user command input, that is, when the user inputs an execution command of a specific function, the emotion recognition apparatus 100 executes the corresponding command and returns to the standby state (720).

When there is no user command input, the sensing part 110 of the emotion recognition apparatus 100 collects user's bio-signals using at least one sensor, and the controller 160 acquires user's emotion information using correlation information between the user's bio-signals and emotion factors. Further, the controller 160 receives user's situation information from an external server or receives the user's situation information input through the input part 120 (730).

The controller 160 determines whether to provide feedback information on the basis of at least one of the user's situation information and the user's emotion information (740). When it is determined that providing the feedback information to the user is inappropriate, the emotion recognition apparatus 100 returns to the standby state.

As described above, whether the emotion recognition apparatus 100 is responded or not may be determined according to the user's situation and the user's emotion, so that the feedback information may be prevented from being provided even in the situation in which feedbacks of the emotion recognition apparatus 100 are unnecessary. Accordingly, a sense of refusal of the user due to the unnecessary feedback information may be prevented from being generated.

When the controller 160 determines to provide the feedback information, the controller 160 controls so that the feedback information is generated and output through the display 150 or the feedback device 170 (750).

The feedback information may include at least one of executable function information corresponding to at least one of the user's emotion information and the user's situation information, and emotion expression images corresponding to the user's emotion information. The emotion expression images are a concept including both static images and dynamic images and include pictures, emoticons, avatars, and the like, which may express emotions. The feedback information may include the executable function information to improve user's emotions to positive emotions or maintain the user's emotions. For example, the executable function information may include playing music, playing video, providing shopping information, providing an optimum path, and the like.

The controller 160 may set a target emotion on the basis of the user's emotion information. When a specific function is selected by the user from the executable function information included in the feedback information, the controller 160 may set the target emotion related to the specific function (760).

When the target emotion is set, the controller 160 extracts emotion factors that affect the user's current emotion from the user's emotion information (770). Further, the controller 160 extracts emotion factors that need to be enhanced or weakened in order for the user's emotion to reach the target emotion.

Thereafter, the controller 160 controls the feedback device 170 so that the user's current emotion reaches the target emotion on the basis of the correlation information between the emotion factors and feedback elements (790). That is, the controller 160 controls the feedback device 170 such that the feedback elements corresponding to the specific emotion factor are adjusted to enhance or weaken the specific emotion factor. Accordingly, the feedback device 170 adjusts the feedback elements related to the specific function selected by the user.

As described above, the emotion recognition apparatus 100 may prevent the feedback information from being provided in a situation in which the feedbacks of the apparatus are unnecessary by determining in advance whether to provide the feedback information on the basis of the user's situation information and the user's emotion information.

Further, the emotion recognition apparatus 100 may allow the user to feel more familiar with the response of the apparatus by variously adjusting the feedback elements according to the user's emotions.

As is apparent from the above description, according to an emotion recognition apparatus and a control method thereof of one aspect of the present disclosure, feedback information can be prevented from being provided in a situation in a situation in which feedbacks of the apparatus are unnecessary by determining in advance whether to provide the feedback information on the basis of user's situation information and user's emotion information.

Further, according to an emotion recognition apparatus and a control method thereof of another aspect of the present disclosure, a user can feel more familiar with a response of the apparatus by variously adjusting feedback elements according to user's emotions.

Further, some forms of the present disclosure may be implemented in the form of a recording medium storing commands executable by a computer. The commands may be stored in the form of program codes and, when executed by a processor, may generate a program module to perform the operations of some forms of the present disclosure. The recording medium may be implemented as a computer-readable recording medium.

The computer-readable recording medium includes all kinds of recording media storing instructions which are decipherable by a computer. For example, there may be a read-only memory (ROM), a random access memory (RAM), a magnetic tape, a magnetic disk, a flash memory, an optical data storage device, and the like.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. An emotion recognition apparatus comprising:
a communicator;
a sensing part configured to collect a user's bio-signal using at least one sensor;
a feedback device configured to adjust a feedback element;
a storage configured to store first correlation information between the user's bio-signal and an emotion factor and second correlation information between the emotion factor and the feedback element; and
a controller configured to:
acquire user's situation information through the communicator;
acquire user's emotion information based on the user's bio-signal;
determine whether feedback information is provided based on at least one of the user's situation information or the user's emotion information; and
control the feedback device to provide the feedback information when the feedback information is provided,
wherein the controller is further configured to:
predict whether the user feels a negative emotion when the feedback information is provided based on the user's situation information;
determine not to provide the feedback information when the user's emotion is in the negative emotion below a predetermined reference; and
generate the feedback information based on the user's emotion information when the feedback information is provided;
wherein the user's situation information includes at least one of current location information, current time information, weather information, or user's schedule information, and
wherein the feedback information comprises at least one of executable function information corresponding to the user's emotion information or an emotion expression image corresponding to the user's emotion information.

2. (canceled)

3. The apparatus of claim 1, wherein the controller is configured to determine whether the feedback information is provided based on the user's emotion information including a degree of positive emotion and a degree of excitement.

4. The apparatus of claim 1, wherein the controller is configured to:
set a target emotion based on the user's emotion information; and
control the feedback device so that a user's current emotion reaches the target emotion.

5. The apparatus of claim 1, wherein the controller is configured to:
acquire the user's emotion information based on the first correlation information; and
control the feedback device based on the second correlation information.

6. The apparatus of claim 4, wherein the controller is configured to:
extract emotion factors affecting the user's current emotion from the user's emotion information; and
control the feedback device to enhance or weaken a specific emotion factor among the extracted emotion factors so that a user's emotion reaches the target emotion.

7. The apparatus of claim 6, wherein the controller is configured to:
control the feedback device such that the feedback element corresponding to the specific emotion factor is adjusted based on the second correlation information.

8. (canceled)

9. The apparatus of claim 1, wherein the controller is configured to:
control the feedback device so that the feedback element related to a specific function is adjusted when the specific function is selected by a user from the executable function information.

10. The apparatus of claim 4, wherein the apparatus further comprises:
an input part configured to receive, from the user, at least one of the user's situation information or the target emotion.

11. The apparatus of claim 1, wherein the feedback device comprises at least one of a display or a speaker.

12. A method for controlling an emotion recognition device, comprising:
collecting a user's bio-signal using at least one sensor;
acquiring user's situation information;
receiving first correlation information between the user's bio-signal and an emotion factor and second correlation information between the emotion factor and a feedback element;
acquiring user's emotion information based on the user's bio-signal;
determining whether feedback information is provided based on at least one of the user's situation information or the user's emotion information; and
controlling a feedback device to provide the feedback information when the feedback information is provided,
wherein determining whether the feedback information is provided further comprises:
predicting whether the user feels a negative emotion when the feedback information is provided based on the user's situation information;
determining not to provide the feedback information when the user's emotion is in the negative emotion below a predetermined reference; and
generating the feedback information based on the user's emotion information when the feedback information is provided,
wherein the user's situation information includes at least one of current location information, current time information, weather information, or user's schedule information, and
wherein the feedback information comprises at least one of executable function information corresponding to the user's emotion information or an emotion expression image corresponding to the user's emotion information.

13. (canceled)

14. The method of claim 12, wherein determining whether the feedback information is provided comprises:
determining whether the feedback information is provided based on the user's emotion information including a degree of positive emotion and a degree of excitement.

15. The method of claim 12, wherein controlling the feedback device further comprises:
setting a target emotion based on the user's emotion information; and
controlling the feedback device so that a user's current emotion reaches the target emotion.

16. The method of claim 12, wherein the method comprises:
acquiring the user's emotion information based on the first correlation information; and
controlling the feedback device based on the second correlation information between the emotion factor and the feedback element.

17. The method of claim 15, wherein controlling the feedback device further comprises:
extracting an emotion factor affecting the user's current emotion from the user's emotion information; and
enhancing or weakening a specific emotion factor of the extracted emotion factors.

18. The method of claim 17, wherein controlling the feedback device further comprises:
adjusting the feedback element corresponding to the specific emotion factor based on the second correlation information between the emotion factor and the feedback element.

19. (canceled)

20. The method of claim 12, wherein controlling the feedback device comprises:
adjusting the feedback element related to a specific function when the specific function is selected by a user from the executable function information.

21. The method of claim 15, wherein the method further comprises:
receiving, from the user, at least one of the user's situation information or the target emotion.
